(19) United States
(12) Patent Application Publication
(10) Pub. No.: US 2024/0220816 A1
(43) Pub. Date: Jul. 4, 2024

(54) SYSTEM AND METHOD FOR FEDERATED LEARNING FOR AUTOMOTIVE APPLICATION WITH KNOWLEDGE DISTILLATION BY TEACHER MODEL

(71) Applicant: WOVEN BY TOYOTA, INC., Tokyo (JP)

(72) Inventors: Yuki Kawana, Tokyo (JP); Yusuke Yachide, Tokyo (JP); Takaaki Tagawa, Tokyo (JP); Koichiro Yamaguchi, Tokyo (JP); Daisuke Hashimoto, Tokyo (JP); Hiroyuki Aono, Tokyo (JP); Ryo Takahashi, Tokyo (JP)

(73) Assignee: WOVEN BY TOYOTA, INC., Tokyo (JP)

(21) Appl. No.: 18/090,993

(22) Filed: Dec. 29, 2022

(51) Int. Cl. G06N 3/098; B60W 60/00

(52) U.S. Cl. CPC G06N 3/098; B60W 60/001

(57) ABSTRACT

A method includes receiving, from one or more server computers through a communication network, a first model and collecting sensor data acquired by a sensor on a vehicle. The method also includes identifying a first data item from among the collected sensor data when the first data item is determined to satisfy a criterion. The method further include deriving an inference signal by running a trained second model using the first data item as input to the second model to provide a training dataset that contains the identified first data item and the derived inference signal as a supervision signal corresponding to the identified first data item. The method further includes training with respect to the first model on the training dataset and transmitting first data representing the trained first model to the one or more server computers though the communication network.

### BACKGROUND

### 1. Field

The disclosure relates generally to a system and method for providing neural network training in autonomous vehicle applications. Specifically, this disclosure relates to providing Federated Learning training to a neural network while maintaining safety and user privacy.

### 2. Description of Related Art

A neural network may be integrated into an application deployed on a multitude of distributed edge devices (e.g., processors or computing devices implemented in hospitals or cellular phones). One method of training such neural networks is Federated Learning (FL), which trains machine learning (ML) models using large amounts of data while ensuring a user's privacy.

To this end, FL techniques consist of a local training phase and a global aggregation phase. In the local training phase, each edge device trains its copy of the neural network with data sensed and used by the application. By performing the training on the edge device, the local data is not exposed or transmitted externally (such as to a remote coordinator or server), thereby ensuring privacy of the edge device user's data. Instead, only the local updates to the neural networks trained on the edge devices are transmitted to a coordinator, which aggregates the updates to generate a new global model. The global model can then be provided to other edge devices for use in the application.

It is critically important that machine learning (ML) models integrated into safety-critical applications, such as computer vision (CL) or other ML applications (e.g., autonomous driving control) in an autonomous vehicle, are trained with large amounts of data in order to ensure accuracy of inference and safety of use in real-world environments. While FL may be applied to these models, there are no reliable supervision signals (e.g., human annotations) for the training in vehicle contexts. As a result, accuracy of inferences may decrease when trained on local data in vehicles.

### SUMMARY

One or more example embodiments provide a system and method for proving driving information to non-driver users.

According to an aspect of the disclosure, a method, implemented by programmed one or more processors, may include: receiving, from one or more server computers through a communication network, a first model; collecting sensor data acquired by a sensor on a vehicle; identifying a first data item from among the collected sensor data when the first data item is determined to satisfy a criterion; deriving an inference signal by running a trained second model using the first data item as input to the second model to provide a training dataset that contains the identified first data item and the derived inference signal as a supervision signal corresponding to the identified first data item; training with respect to the first model on the training dataset; and transmitting first data representing the trained first model to the one or more server computers though the communication network.

According to an aspect of the disclosure, a computing device may include a memory storing instructions and a processor configured to execute the instructions to: receive, from one or more server computers through a communication network, a first model; collect sensor data acquired by a sensor on a vehicle; identify a first data item from among the collected sensor data when the first data item is determined to satisfy a criterion; derive an inference signal by running a trained second model using the first data item as input to the second model to provide a training dataset that contains the identified first data item and the derived inference signal as a supervision signal corresponding to the identified first data item; train with respect to the first model on the training dataset; and transmit first data representing the trained first model to the one or more server computers though the communication network.

According to an aspect of the disclosure, a non-transitory computer-readable medium may store instructions, the instructions comprising: one or more instructions that, when executed by one or more processors of a device, cause the one or more processors to: receive, from one or more server computers through a communication network, a first model; collect sensor data acquired by a sensor on a vehicle; identify a first data item from among the collected sensor data when the first data item is determined to satisfy a criterion; derive an inference signal by running a trained second model using the first data item as input to the second model to provide a training dataset that contains the identified first data item and the derived inference signal as a supervision signal corresponding to the identified first data item; train with respect to the first model on the training dataset; and transmit first data representing the trained first model to the one or more server computers though the communication network.

Additional aspects will be set forth in part in the description that follows and, in part, will be apparent from the description, or may be learned by practice of the presented embodiments of the disclosure.

### BRIEF DESCRIPTION OF THE DRAWINGS

The above and other aspects, features, and aspects of embodiments of the disclosure will be more apparent from the following description taken in conjunction with the accompanying drawings, in which:

FIG. 1 is a diagram of a system according to an embodiment;

FIG. 2 is a diagram of components of an autonomous vehicle of FIG. 1 according to an embodiment;

FIG. 3 is a diagram of data processing associated with training a neural network for a plurality of autonomous vehicles according to an embodiment;

FIG. 4 is a diagram of data processing associated with training a neural network for a single autonomous vehicle according to an embodiment;

FIG. 5 is a flowchart for a method of training a neural network for a autonomous vehicles according to an embodiment.

### DETAILED DESCRIPTION

The following detailed description of example embodiments refers to the accompanying drawings. The same reference numbers in different drawings may identify the same or similar elements.

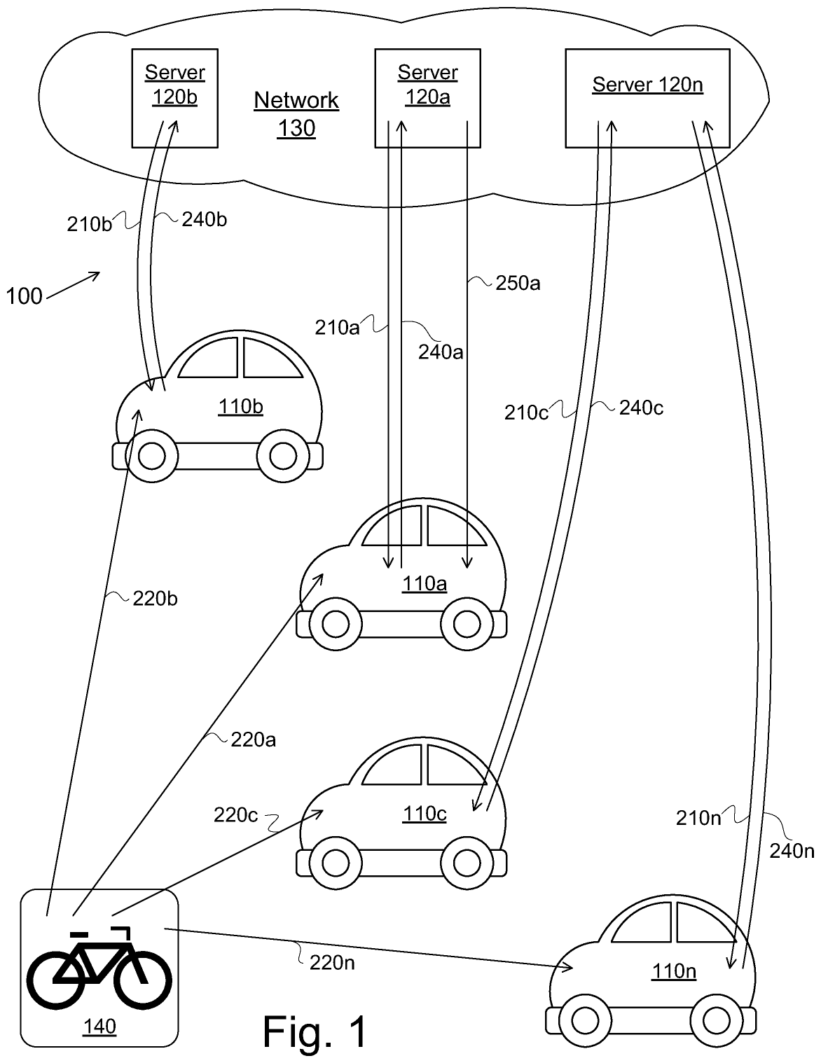

FIG. 1 is a diagram of a system 100 according to an embodiment. System 100 includes one or more of vehicles 110a-n and one or more server computers 120a-n. The one or more server computers 120a-n may connect with each other and each of the vehicles 110a-n via, for example, a communications network 130.

Disclosed embodiments may involve receiving from one or more server computers 120. A server computer 120 as used in this disclosure may include a general purpose computer, a personal computer, a workstation, a mainframe computer, a notebook, a global positioning device, a laptop computer, a smart phone, a personal digital assistant, a network server, and any other electronic device that may interact with a user to develop programming code.

In some embodiments, the server computer 120 may include a processor, a display device, memory device, and other components including those components that facilitate electronic communication. Other components may include user interface devices such as an input and output devices. The server computer 120 may include computer hardware components such as a combination of Central Processing Units (CPUs) or processors, buses, memory devices, storage units, data processors, input devices, output devices, network interface devices, and other types of components that will become apparent to those skilled in the art. The server computer 120 may further include application programs that may include software modules, sequences of instructions, routines, data structures, display interfaces, and other types of structures that execute operations of the present disclosure.

Disclosed embodiments may involve receiving through a communication network 130. A communication network as used in this disclosure may include a set of computers (such as the one or more server computers 120) sharing resources located on or provided by network nodes. This set of computers may use common communication protocols over digital interconnections to communicate with each other. These interconnections may be made up of telecommunication network technologies, based on physically wired, optical, and wireless radio-frequency methods that may be arranged in a variety of network topologies. For example, these interconnections may take place through databases, servers, RF (radio frequency) signals, cellular technology, Ethernet, telephone, “TCP/IP” (transmission control protocol/internet protocol), and any other electronic communication format. For example, the network 130 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of servers 120 and networks 130 shown in FIG. 1 are provided as an example. In practice, there may be additional servers 120 and/or networks 130, fewer servers 120 and/or networks 130, different servers 120 and/or networks 130, or differently arranged servers 120 and/or networks 130 than those shown in FIG. 1. Furthermore, two or more servers 120 shown in FIG. 1 may be implemented within a single server 120, or a single server 120 shown in FIG. 1 may be implemented as multiple, distributed servers 130. Additionally, or alternatively, a set of servers 120 (e.g., one or more servers 120) may perform one or more functions described as being performed by another set of servers 120.

In some embodiments, the communications network 130 may be set up as a neural network. A neural network may be based on a collection of connected units or nodes called artificial neurons, which loosely model the neurons in a biological brain. Each connection, like the synapses in a biological brain, may transmit a signal to other neurons. An may artificial neuron receive signals to process and may then signal other neurons connected to it. These signals at a connection may be real numbers, and the output of each neuron may be computed by some non-linear function of the sum of its inputs. These connections may be edges (such as the autonomous vehicles 110). Neurons and edges may have a weight that adjusts as learning proceeds. The weight may increase or decrease the strength of the signal at a connection. Neurons may have a threshold such that a signal may be sent only if the aggregate signal crosses that threshold. Neurons may be aggregated into layers. Different layers may perform different transformations on their inputs. Signals may travel from a first layer (e.g., an input layer), to a last layer (e.g., an output layer), through potential intermediate layers and may do so multiple times.

As will be explained in further detail below, Federated Learning (FL) may be used to train neural networks of safety-critical automotive applications by incorporating a second neural network (a teacher model) to derive an inference signal as a supervision signal for training. By applying FL, large amounts of data can be used to train the neural networks, thereby increasing the accuracy of inferences. Further, by applying FL, data privacy for a user (i.e., operator of a vehicle 110) can be ensured. Additionally, by incorporating a second model dedicated to training in the edge device, the second model can be more robust and computationally heavier than the edge model integrated in the application (which must be lighter weight for real time use), and therefore provide more accurate inferences than the edge model. Finally, as the inferences from the second model are used as supervision signals, the accuracy of inferences or predictions by the edge model can increase.

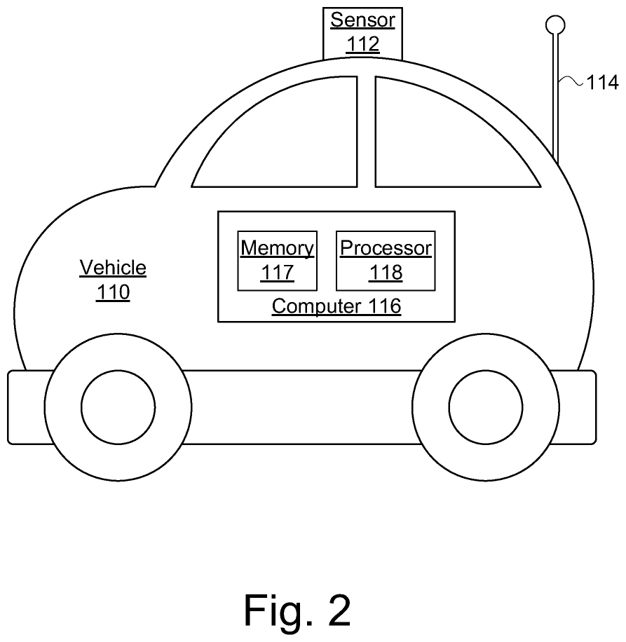

A more detailed view of a vehicle 110 may be seen in FIG. 2. Each of the vehicles 110 may include one or more sensors 112, one or more transceivers 114, and a vehicle computer 116.

The one or more transceivers 114 as used in this disclosure may include one or more components (e.g., a transceiver and/or a separate receiver and transmitter) that enables the vehicle 110 to communicate with other vehicles 110 and or the one or more server computers 120, such as via a wired connection, a wireless connection, or a combination of wired and wireless connections. The one or more transceivers 114 may permit vehicle 110 to receive information from another vehicle 110/server computer 120 and/or provide information to another vehicle 110/server computer 120. For example, the one or more transceivers 114 may include an Ethernet interface, an optical interface, a coaxial interface, an infrared interface, a radio frequency (RF) interface, a universal serial bus (USB) interface, a Wi-Fi interface, a cellular network interface, or any other interface capable of sending or receiving electric/electromagnetic information.

As seen in FIG. 2, the vehicle computer 116 as used in this disclosure may include a bus (not shown), a memory 117, a processor 118, an input component (not shown), and an output component (not shown).

The bus includes a component that permits communication among the components of the vehicle computer 116.

The processor 118 may be implemented in hardware, firmware, or a combination of hardware and software. The processor 118 may be at least one of a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. The processor 118 may include one or more processors capable of being programmed to perform a function.

The memory 117 includes a random access memory (RAM), a read only memory (ROM), and/or another type of dynamic or static storage device (e.g., a flash memory, a magnetic memory, and/or an optical memory) that stores information and/or instructions for use by the processor 118. The memory 117 may also store information and/or software related to the operation and use of the vehicle computer 116. For example, the memory 117 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component may include a component that permits the vehicle computer 116 to receive information, such as via user input (e.g., a touch screen display, a keyboard, a keypad, a mouse, a button, a switch, and/or a microphone). The input component may include a sensor for sensing information (e.g., a global positioning system (GPS) component, an accelerometer, a gyroscope, and/or an actuator).

The output component may include a component that provides output information from the vehicle computer 116 (e.g., a display, a speaker, and/or one or more light-emitting diodes (LEDs)).

The vehicle computer 116 may perform one or more processes described herein. The vehicle computer 116 may perform operations based on the processor 118 executing software instructions stored by a non-transitory computer-readable medium, such as the memory 117. A computer-readable medium is defined herein as a non-transitory memory device. A memory device includes memory space within a single physical storage device or memory space spread across multiple physical storage devices.

Software instructions may be read into the memory 117 from another computer-readable medium or from another device via the one or more transceivers 114. When executed, software instructions stored in the memory 117 may cause the processor 118 to perform one or more processes described herein.

Additionally, or alternatively, hardwired circuitry may be used in place of or in combination with software instructions to perform one or more processes described herein. Thus, embodiments described herein are not limited to any specific combination of hardware circuitry and software.

Disclosed embodiments may involve receiving a first model 210 (e.g., the first model 210a). A first model 210 as used in this disclosure may include machine learning models. The machine learning models may be configured to be integrated into applications running on an autonomous vehicle (such as vehicle 110a). The applications running on an autonomous vehicle 110 may be safety-critical applications such as computer vision, autonomous driving control, and other machine learning applications associated with the operation of the autonomous vehicle 110. Autonomous driving control may include autonomous control of acceleration, braking, steering, transmission, and any other systems that may affect the movement of the vehicle 110 through its environment.

In some embodiments, the first model 210 (e.g., first model 210a) may be associated with detection of an object 140 that the vehicle 110 (e.g., vehicle 110a) may encounter. The object may be another vehicle, a pedestrian, a wildlife animal, a road hazard, or any other aspect of the environment that could potentially interact with the vehicle 110. For example, in FIG. 1, the object 140 is depicted as bicycle on a roadway.

In some embodiments, the first model 210 (e.g., first model 210a) may be associated with sensory interpretation. For example, one type of sensory interpretation may include image segmentation. Image segmentation may partition a digital image into multiple image segments, (e.g., image regions or image objects (sets of pixels)). Image segmentation may simplify and/or change a representation of an image into something more meaningful and/or easier to analyze. Image segmentation is may be used to locate objects and boundaries (e.g., lines and curves) in images. Image segmentation may involve assigning a label to various pixels in an image such that pixels with the same label share certain characteristics.

As seen in FIGS. 1 and 2, the vehicle 110a may receive the first model 210a via the one or more transceivers 114 and store the received first model 210a, for example, in the memory 117 of the vehicle computer 116 of vehicle 110a. Similarly, other vehicles 110b-n may each receive a first model (e.g., first model 210b, first model 210c, first model 210n) similar to that of the first model 210a at their respective transceivers 114 and store the respective received first models 210b-n, for example, in the memory 117 of the vehicle computer 116 of the other vehicles 110b-n.

Disclosed embodiments may involve collecting sensor data 220a acquired by one or more sensors 112 in vehicle 110a. A sensor 112 as used in this disclosure may include cameras, camcorders, microphones, LiDAR, or any other devices configured collect sensor data 220a. Sensor data 220a as used in this disclosure may include photographs, video recording, sound recording, LiDAR data, or any other measurement recordings of the environment surrounding the vehicle 110a. Similarly, other vehicles 110b-n may each collect sensor data 220b-n via their respective sensors 112.

As seen in FIGS. 1 and 2, the vehicle 110a may receive the sensor data 220a via the one or more sensors 112 and store the received sensor data 220a, for example, in the memory 117 of the vehicle computer 116. Similarly, other vehicles 110b-n may each store their collected sensor data 220b-n via their respective memories 117 of their vehicle computers 116.

Disclosed embodiments may involve a vehicle 110. A vehicle 110 as used in this disclosure may include a car, a van, a truck, a bus, a motorcycle, a moped, a drone, a robot, or any other locomotive device capable of complete or partial autonomous movement.

As seen in FIG. 1, system 100 may include multiple vehicles 110a-n. Each of the vehicles 110a-n may be substantially similar or different than any of the other vehicles 110a-n. In some embodiments, all of the vehicles 110a-n could be the same model autonomous car with similar sensory and motive capabilities/configurations. In other embodiments, all of the vehicles 110a-n could be different model autonomous vehicles with a variety of different sensory and motive capabilities/configurations. In other embodiments, some of the vehicles 110a-n could be of similar configurations while others could be of different configurations.

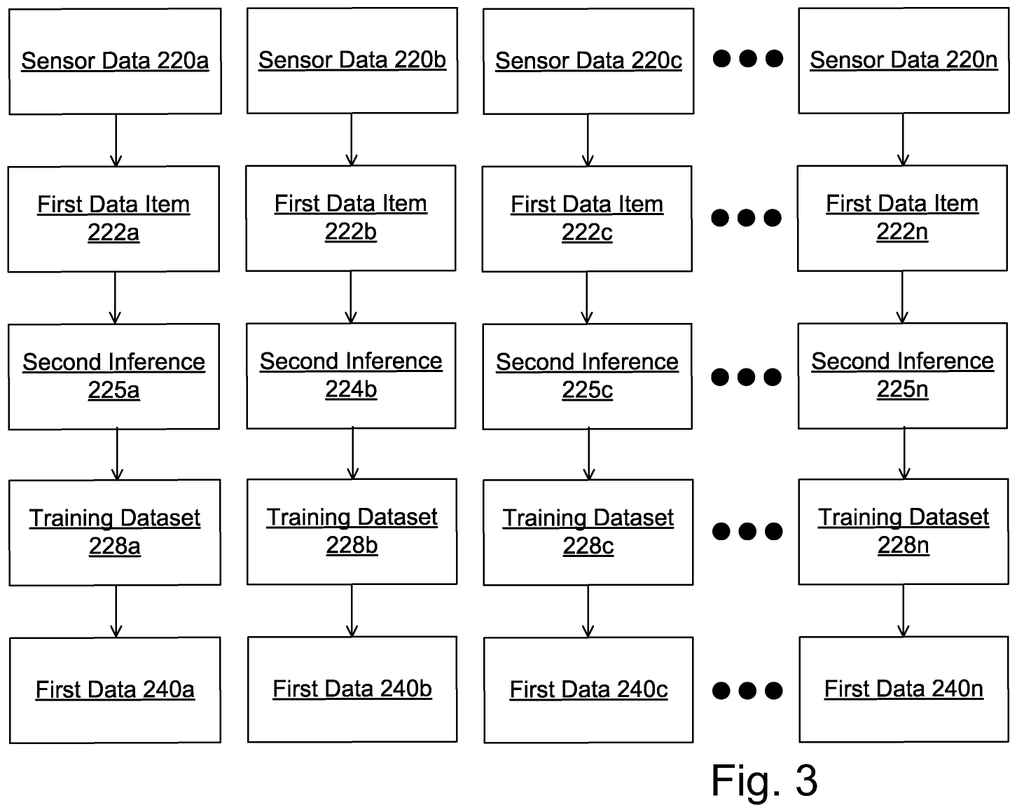

Disclosed embodiments may involve identifying a first data item 222a from among the collected sensor data 220a. A first data item 222a as used in this disclosure may include a subset of the sensor data 220a received by the vehicle 110a that may be useful for training the first model 210a so as to improve accuracy of inference and safety of use in real-world environments. In a similar way, for example as seen in FIG. 3, the other vehicles 110b-n may involve identifying other data items (e.g., first data item 222b, first data item 222c, first data item 222n) similar to that of the first data item 222a.

Disclosed embodiments may involve identifying when the first data item 222a is determined to satisfy a criterion. A criterion as used in this disclosure may include: (i) vehicle information (e.g., speed, steering, and braking) when the data is sensed (e.g., a speed that is greater than or equal to a predetermined speed, or a braking when the speed is greater than or equal to a predetermined speed, steering that is greater than or equal to a predetermined degree or amount, steering that is greater than or equal to a predetermined amount when the speed is greater than or equal to a predetermined speed, or any other conditions associated with vehicle movement useful for training the first model 210); (ii) a position of the vehicle (e.g., as determined by inertial measurement unit (IMU), global positioning system (GPS), or any other sensors that may be used to determine relative or absolute location/orientation of the vehicle 110a) when the data is sensed; a time when the data is sensed; driver monitoring information when the data is sent; (iii) image recognition results (e.g., scene classification, variance of numbers of detected objects, road structure, or any other meaningful characteristics of the environment around the vehicle 110a); (iv) uniqueness/clustering of image features; (v) uncertainty metrics; (vi) and/or any other discernable characteristics indicative of being useful for training the first model 210. In a similar way, other vehicles 110b-n may identify when their respective data items 222b-n are determined to satisfy a criterion.

Evaluation of the first data item 222 (e.g., first data item 222a) may include detecting an object 140 contained in the identified first data item 222. Detecting an object 140 as used in this disclosure may include identifying portions of the first data item 222 indicative of a real world presence of the object 140 in the environment. Information regarding the real world presence of the object 140 in the environment may include characteristics of the object including location, orientation, size, speed, trajectory, or any other physical/behavioral features of the object 140. As seen in FIG. 1, detecting an object 140 may include determining that portions of the first data item 222a are indicative of a bicycle moving at a particular speed, in a particular direction, on a particular part of a road.

Disclosed embodiments may include a trained second model 215 (e.g., second model 215a). The second model 215, like the first model 210, may include machine learning models. The machine learning models may be configured specifically for training in the vehicle 110 (e.g. vehicle 110a). The second model 215 may be substantially similar to the first model 210 in terms of the ability to evaluate sensor data 220. However, while the application integrated first model 210 may be relatively light weight for real time use, the second model 215 may be more robust and computationally heavy in order to act a teacher model. In some embodiments, the second model 215 may be pre-installed in the, for example, memory 117 of the vehicle computer 116 of the vehicle 110. In some embodiments, vehicle 110a may receive the second model 215 via the one or more transceivers 114 and store the received second model 215, for example, in the memory 117 of the vehicle computer 116 of vehicle 110.

Disclosed embodiments may include inputting the first data item 222 (e.g., first data item 222a) into the first model 210 (e.g., first model 210a). In some embodiments, after (i) the first model 210 has been received from the server computer 120 and stored in the memory 117 of the vehicle computer 116 of the vehicle 110 (e.g., vehicle 110a), and (ii) the first data item 222 has been stored in the memory 117 and identified by the processor 118 of the vehicle 110, the processor 118 may input the first data item 222 into the first model 210 to detect the object 140 as an output of a first inference 223 (e.g., first inference 223a). Running of the first model 210 may result in detection of the object 140 and generate the first inference 223 with one or more particular confidence scores 224 (e.g., confidence score 224a). These confidence scores 224 may indicate a degree to which the first model's 210 perception of the presence, characteristics, and behavior of the object 140 (i.e., the first inference 223) matches the reality of the object 140 in the real world environment. For example, the processor 118 may determine after running the first data item 222a through the first model 210a that as the first inference 223a, a bicycle has been detected heading north at twenty miles per hour and that the detected bicycle will continue on this trajectory. In this example, the first inference 223a may have a confidence score 224a of 80% indicating that the first inference 223a is 80% likely to match the reality of the object 140 in the real world.

Disclosed embodiments may include identifying the first data item 222 (e.g., the first data item 222a) for training based on the confidence score 224 (e.g., confidence score 224a) being less than a predetermined value. In the above example where the first inference 223a (i.e., that a bicycle has been detected heading north at twenty miles per hour and that the detected bicycle will continue on this trajectory) had a confidence score 224a of 80%, (i) if the predetermined value was set at, for example, 85%, then the first data item 222a would be identified for training, and (ii) if the predetermined value was set at, for example 75%, then the first data item 222a would not be identified for training.

Disclosed embodiments may include inputting the first data item 222 (e.g., first data item 222a) into the second model 215 (e.g., first model 210a) to derive an inference signal (e.g., second inference 225a) as an output. In some embodiments, after the first data item 222 has been stored in the memory 117 and identified by the processor 118 of the vehicle 110, the processor 118 may input the first data item 222 into the second model 215 to detect the object 140 as a second inference 225 (e.g., second inference 225a). Running of the second model 215 may result in detection of the object 140 and generate the second inference 225. For example, the processor 118 may determine after running the first data item 222a through the second model 215a that as the second inference 225a, a bicycle has been detected heading north at twenty-five miles per hour and that the detected bicycle will continue on this trajectory.

Disclosed embodiments may include comparing outputs of the first model 210 and the second model 215. As used in this disclosure, outputs of the first model 210 and the second model 215 may include the first inference 223 and the second inference 225 respectively. In the above example when the first inference 223a (i.e., that a bicycle has been detected heading north at twenty miles per hour and that the detected bicycle will continue on this trajectory) is compared to the second inference 224a (i.e., that a bicycle has been detected heading north at twenty-five miles per hour and that the detected bicycle will continue on this trajectory), it is seen that a difference between the outputs is a five miles per hour speed difference.

Disclosed embodiments may include identifying the first data item 222 (e.g., the first data item 222a) for training based on a difference between the outputs (e.g., inferences 223a, 225a) being greater than a predetermined value. In the above example where difference between the first inference 223a (i.e., that a bicycle has been detected heading north at twenty miles per hour and that the detected bicycle will continue on this trajectory) and the second inference 225a (i.e., that a bicycle has been detected heading north at twenty-five miles per hour and that the detected bicycle will continue on this trajectory), is a five miles per hour speed difference, (i) if the predetermined value was set at, for example, three miles per hour, then the first data item 222a would be identified for training, and (ii) if the predetermined value was set at, for example ten miles per hour, then the first data item 222a would not be identified for training.

Disclosed embodiments may involve providing a training dataset 228a containing the identifies first data item 222a, and the derived inference signal 225a. Generating a training dataset 228a as used in this disclosure may include aggregating relevant information in a way that is useful for training a machine learning model. Similarly, for example as seen in FIG. 3, the other vehicles 110b-n may generate their own training datasets (e.g., training dataset 228b, training dataset 228c, training dataset 228n) to include the first data item 222b-n and the derived inference signals 225b-n corresponding to the respective vehicles 110b-n.

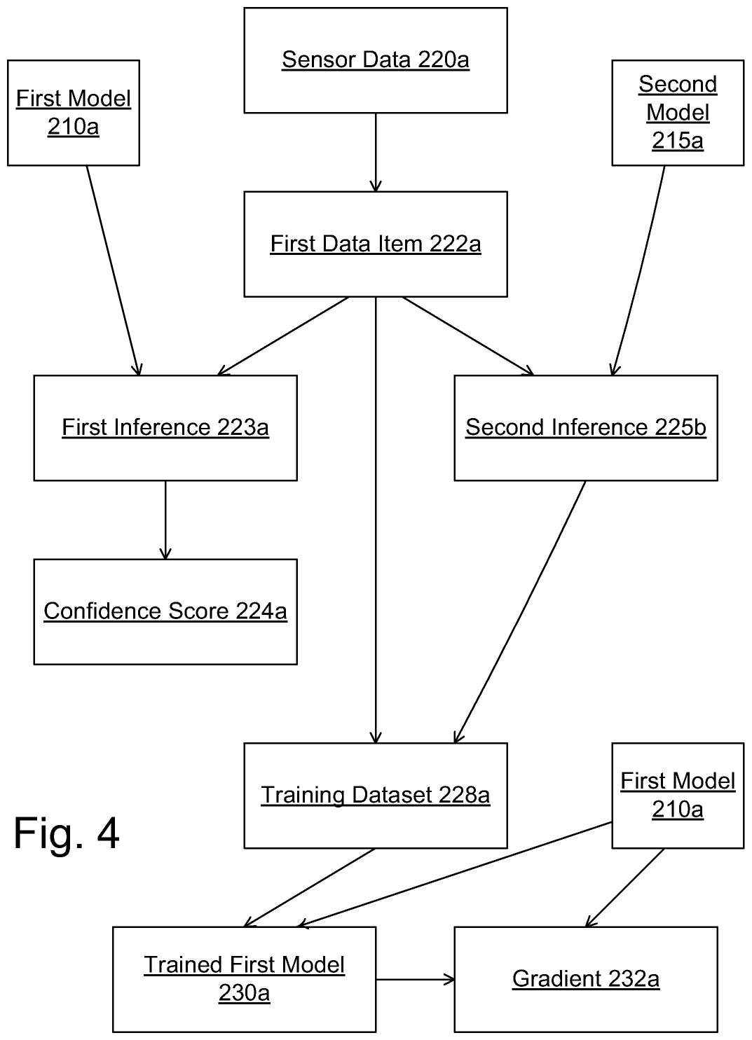

Disclosed embodiments may involve deriving the inference signal 225a as a supervision signal. A supervision signal as used in this disclosure may include a training example having an input and a desired output value. The input may include the inference signal 225a (e.g., as seen in FIG. 4). The desired output value may include a pseudo-label for the first data item 222a. Similarly, the inference signals 225b-n associated with the vehicles 110b-n may also be derived as a supervision signal.

Disclosed embodiments may involve training with respect to the first model 210a on the training dataset 228a. Training as used in this disclosure may include a local training phase associated with FL. As seen in FIG. 4, training of the first model 210a with the training dataset 228a may result in the generation of a trained first model 230a. The trained first model 230a may be capable of generating inferences at a higher confidence level than the untrained first model 210a. For example, the processor 118 may determine after running the first data item 222a through the trained first model 230a that as a trained first inference, there is 90% confidence (up from the first inference 223a of 80% using the original first model 210a), a bicycle has been detected heading north at twenty miles per hour and that the detected bicycle will continue on this trajectory. Similarly, other vehicles 110b-n may train their respective edge models 210b-n on their respectively generated training datasets 228b-n to generate trained edge models 230b-n.

In some embodiments, the training with respect to the first model 210a includes training a copy of the received first model 210a. By training on a copy of the first model 210a, the original first model 210a may be preserved post training. Accordingly the performance of the original first model 210a may be compared with that of the trained first model 230a such that the model 210a, 230a capable of producing inferences with higher confidence levels may be used going forward. Similarly, other vehicles 110b-n may train their on a copy of their respective edge models 210b-n.

Disclosed embodiments may involve transmitting first data 240a representing the trained first model 230a to the one or more server computers 120 though the communication network 130. By sending the first data 240a representing the trained first model 230a (acquired by performing the training locally) as opposed to sending the training dataset 228a to the one or more servers 120 for training, a user's data privacy may be safeguarded. Similarly, as seen in FIG. 3, other vehicles 110b-n may generate their own first data (e.g., first data 240b, first data 240c, first data 240n) that may subsequently be transmitted to the one or more servers 120.

Disclosed embodiments may involve obtaining, as the first data 240a, a gradient 232a between the first model 210a prior to the training and the first model 230a subsequent to the training. A gradient 232a as used in this disclosure may include update parameters (e.g., weights) representing the differences between the first model 210a and the trained first model 230a. By sending only the gradient 232a and not the entirety of the updated/trained model 230a, a transmission overhead may be reduced thereby improving performance of the communication network 130. Similarly, other vehicles 110b-n may obtain, as their respective data 240b-n, gradients 232b-n between their respective edge models 210b-n and trained edge models 230b-n that may subsequently be transmitted to the one or more servers 120.

Disclosed embodiments may involve receiving, from the one or more server computers 120 through a communication network 130, second data 250a that represents a model that is trained with aggregated model information from other edge models. Second data 250a as used in this disclosure may include the result of a global aggregation phase associated with FL. For example, the one or more server computers 120 may aggregates the data 240a-n (e.g., either the trained models 230a-n or the gradients 232a-n) received from each of plural edge vehicles 110a-n relative to the first model 210a and updates the first model 210a accordingly. The second data 250a may represent the updated first model itself, or a gradient between the updated first model and the original first model 210a. Similarly, the other vehicles 110b-n may each respectively receive second data 250b-n. The second data 250b-n may represent an update to the respective models 210b-n based on an aggregation of the data 240a-n relative to the respective models 210b-n. The second data 250b-n may each be substantially the same or different from second data 250a. In some embodiments second data 250a is sent from the one or more server computers 120 to each of the edge vehicles 110a-n

Disclosed embodiments may involve updating the first model 210a based on the second data 250a. After updating the first model 210a (and potentially the trained first model 230a if both copies are stored in the memory 117) with the second data 250a, the updated first model may be capable of generating inferences at a higher confidence level relative to both the original first model 210a and the trained first model 230a. For example, the processor 118 may determine after running the first data item 222a through the updated first model that as an updated first inference, there is 95% confidence (up from 90% using the trained first model 230a and up from 80% using the original first model 210a), that a bicycle has been detected heading north at twenty miles per hour and that the detected bicycle will continue on this trajectory. Similarly, other vehicles 110b-n may update their respective edge models 210b-n respectively with second data 250b-n. Alternatively, the other vehicles 110b-n may update their respective edge models 210b-n with second data 250a.

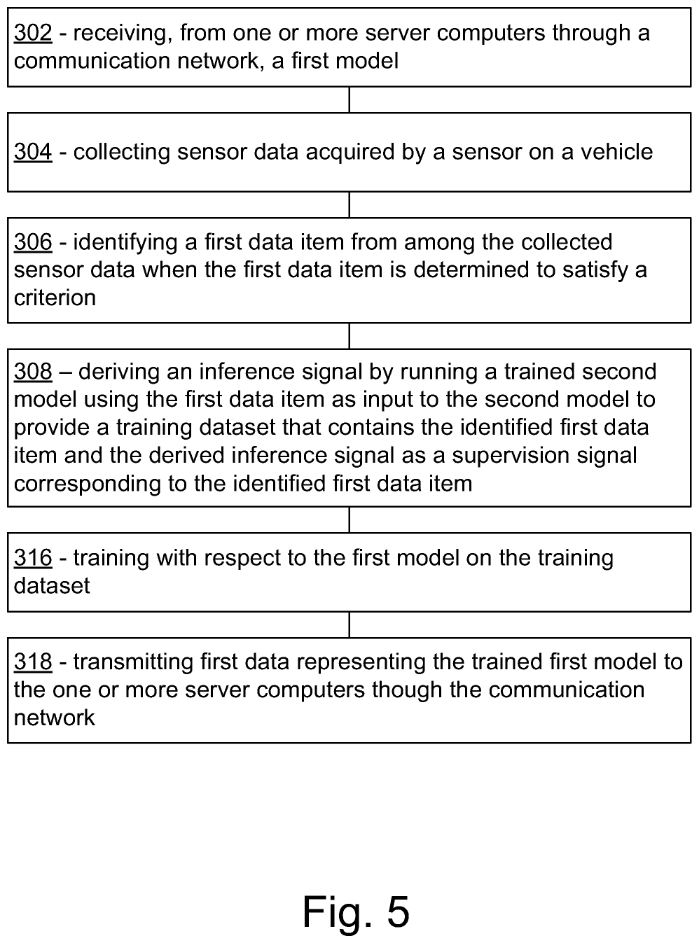

FIG. 5 is a flowchart for a method of providing FL training a neural network for autonomous driving vehicles according to an embodiment. Referring to FIG. 5, in operation 302, the system receives, from one or more server computers through a communication network, a first model. In operation 304, the system collects sensor data acquired by a sensor on a vehicle. In operation 306, the system identifies a first data item from among the collected sensor data when the first data item is determined to satisfy a criterion. In operation 308, the system derives an inference signal by running a trained second model using the first data item as input to the second model to provide a training dataset that contains the identified first data item and the derived inference signal as a supervision signal corresponding to the identified first data item. In operation 310, the system trains with respect to the first model on the training dataset. In operation 312, the system transmits first data representing the trained first model to the one or more server computers though the communication network.

It is understood that one or more operations of the above-described methods may be omitted or combined with other operations, and one or more additional operations may be added.

Utilizing the above described method, several advantages are achieved over conventional autonomous vehicle training techniques. By performing the training locally as opposed to sending the training data to the coordinator, a user's data privacy is ensured. By incorporating a second model dedicated to training in the edge device, the second model can be more robust and computationally heavier than the edge model integrated in the application (which must be lighter weight for real time use), and therefore provide more accurate inferences than the edge model. By using inferences from the second model as supervision signals, the accuracy of inferences or predictions by the edge model can increase. By sending only the gradient and not the updated/trained model, a transmission overhead is reduced thereby improving performance of the communication network. By aggregating updates to the ML model from plural edge devices, the ML model can be effectively trained with a large amount of data, thereby improving performance (accuracy of inference).

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term “component” is intended to be broadly construed as hardware, firmware, or a combination of hardware and software.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples.

While such terms as “first,” “second,” etc., may be used to describe various elements, such elements must not be limited to the above terms. The above terms may be used only to distinguish one element from another.

What is claimed is:

1. A method, implemented by programmed one or more processors, comprising:
receiving, from one or more server computers through a communication network, a first model;
collecting sensor data acquired by a sensor on a vehicle;
identifying a first data item from among the collected sensor data when the first data item is determined to satisfy a criterion;
deriving an inference signal by running a trained second model using the first data item as input to the second model to provide a training dataset that contains the identified first data item and the derived inference signal as a supervision signal corresponding to the identified first data item;
training with respect to the first model on the training dataset; and
transmitting first data representing the trained first model to the one or more server computers though the communication network.

2. The method according to claim 1, further comprising:
receiving, from the one or more server computers through a communication network, second data that represents a model that is trained with aggregated model information from other edge models; and
updating the first model based on the second data.

3. The method according to claim 1, wherein the training with respect to the first model comprises training a copy of the received first model.

4. The method according to claim 1, further comprising obtaining, as the first data, a gradient between the first model prior to the training and the first model subsequent to the training.

5. The method according to claim 3, further comprising obtaining, as the first data, a gradient between the received first model and the copy of the first model that is updated by the training.

6. The method according to claim 1, wherein the identifying the first data item comprises:
inputting the first data item to both the first model and the second model and comparing outputs of the first model and the second model; and
based on a difference between the outputs being greater than a predetermined value, identifying the first data item for training.

7. The method according to claim 1, wherein the identifying the first data item comprises:
inputting the first data item to the first model in real time and obtaining an output and a confidence score for the output; and
based on the confidence score being less than a predetermined value, identifying the first data item for training.

8. A computing device, comprising:
a memory storing instructions; and
a processor configured to execute the instructions to:
receive, from one or more server computers through a communication network, a first model;
collect sensor data acquired by a sensor on a vehicle;
identify a first data item from among the collected sensor data when the first data item is determined to satisfy a criterion;
derive an inference signal by running a trained second model using the first data item as input to the second model to provide a training dataset that contains the identified first data item and the derived inference signal as a supervision signal corresponding to the identified first data item;
train with respect to the first model on the training dataset; and
transmit first data representing the trained first model to the one or more server computers though the communication network.

9. The computing device according to claim 8, wherein the processor is further configured to execute the instructions to:
receive, from the one or more server computers through a communication network, second data that represents a model that is trained with aggregated model information from other edge models; and
update the first model based on the second data.

10. The computing device according to claim 8, wherein the instructions to train with respect to the first model comprises instructions to train a copy of the received first model.

11. The computing device according to claim 8, wherein the processor is further configured to execute the instructions to obtain, as the first data, a gradient between the first model prior to the training and the first model subsequent to the training.

12. The computing device according to claim 10, wherein the processor is further configured to execute the instructions to obtain, as the first data, a gradient between the received first model and the copy of the first model that is updated by the training.

13. The computing device according to claim 8, wherein the instructions to identify the first data item comprises instructions to:
input the first data item to both the first model and the second model and comparing outputs of the first model and the second model; and
based on a difference between the outputs being greater than a predetermined value, identify the first data item for training.

14. The computing device according to claim 8, wherein the instructions to identify the first data item comprises instructions to:
input the first data item to the first model in real time and obtaining an output and a confidence score for the output; and
based on the confidence score being less than a predetermined value, identify the first data item for training.

15. A non-transitory computer-readable medium storing instructions, the instructions comprising: one or more instructions that, when executed by one or more processors of a device, cause the one or more processors to:
receive, from one or more server computers through a communication network, a first model;
collect sensor data acquired by a sensor on a vehicle;
identify a first data item from among the collected sensor data when the first data item is determined to satisfy a criterion;
derive an inference signal by running a trained second model using the first data item as input to the second model to provide a training dataset that contains the identified first data item and the derived inference signal as a supervision signal corresponding to the identified first data item;
train with respect to the first model on the training dataset; and
transmit first data representing the trained first model to the one or more server computers though the communication network.

16. The non-transitory computer-readable medium of claim 15, wherein the instructions further comprise: one or more instructions that, when executed by one or more processors of a device, cause the one or more processors to:
receive, from the one or more server computers through a communication network, second data that represents a model that is trained with aggregated model information from other edge models; and
update the first model based on the second data.

17. The non-transitory computer-readable medium of claim 15, wherein causing the one or more processors to train with respect to the first model comprises causing the one or more processors to train a copy of the received first model.

18. The non-transitory computer-readable medium of claim 15, wherein the instructions further comprise: one or more instructions that, when executed by one or more processors of a device, cause the one or more processors to obtain, as the first data, a gradient between the first model prior to the training and the first model subsequent to the training.

19. The non-transitory computer-readable medium of claim 15, wherein causing the one or more processors to receive the second data item comprises causing the one or more processors to:
input the first data item to both the first model and the second model and comparing outputs of the first model and the second model; and
based on a difference between the outputs being greater than a predetermined value, identify the first data item for training.

20. The non-transitory computer-readable medium of claim 15, wherein causing the one or more processors to receive the second data item comprises causing the one or more processors to:
input the first data item to the first model in real time and obtaining an output and a confidence score for the output; and
based on the confidence score being less than a predetermined value, identify the first data item for training.
